(19) United States
(12) Patent Application Publication
(10) Pub. No.: US 2020/0256123 A1
(43) Pub. Date: Aug. 13, 2020

(54) VERTICAL BLINDS

(71) Applicant: ABO WINDOW FASHION CORP, Chino, CA (US)

(72) Inventor: Shan-Chi Chuang, New Taipei City (TW)

(21) Appl. No.: 16/273,555

(22) Filed: Feb. 12, 2019

(51) Int. Cl. E06B 9/36; E06B 9/326

(52) U.S. Cl. CPC E06B 9/364; E06B 9/326

(57) ABSTRACT

A vertical blind structure has: an upper track, at least one track set and a plurality of blades. The upper track with an adjustable length has an inner track and an outer track, and the inner track and the outer track are disposed on a same side and connected to each other with a connecting track. The inner and outer tracks of the upper track respectively have an engaging portion and further have a plurality of clamping members. The at least one track set has a plurality of sliding tracks parallel with each other, and each sliding track has a positioning groove and a corresponding limiting groove at two opposite sides and a storing groove at a bottom side. An end of each positioning groove of the sliding track comprises a sliding block.

### BACKGROUND of INVENTION

### 1. Field of Invention

The present invention relates to blinds, and more particularly to a vertical blinds structure.

### 2. Description of the Related Art

According to the conventional vertical blinds structure, as shown in FIG. 17, the vertical blinds 40 include a support base 41, and a plurality of slide tracks 42 (shown with 3) arranged side by side on the support base 41 are respectively arranged on the rails rod 43 of each slide rails 42. The upper end of the rail 43 is coupled with two pulleys 431 disposed in the slide track 42. The blades 44 are respectively disposed on each rail 43, and a pull cord 45 is disposed on the support base 41 and drives a pulley 431 to move. The rail 43 is provided with a plurality of the limiting blocks 432 as a stopper for each pulley 431.

It is not difficult to find out that the above-mentioned conventional structure has some shortcomings. The main reason is as follows: the rail 43 of the conventional blinds structure are slidably disposed in the sliding track 42 of the support base 41 through the pulley 431, therefore the track 42 of the support base 41 must be matched with the size of the pulley 431, which results in an increase in the manufacturing cost and the packaging volume of the support base 41 and also increases the difficulty in assembling the assembly, which is necessary for improvement.

Therefore, it is desirable to provide a vertical blinds structure to mitigate and/or obviate the aforementioned problems.

### SUMMARY OF THE INVENTION

An objective of present invention is to provide a vertical blinds structure with improvements.

To achieve these and other objects of the present invention, a vertical blind structure comprises: an upper track, at least one track set and a plurality of blades. The upper track with an adjustable length has an inner track and an outer track, and the inner track and the outer track are disposed on a same side and connected to each other with a connecting track. The inner and outer tracks of the upper track respectively have an engaging portion and further have a plurality of clamping members. The clamping member has a clasping portion and an assembly opening at a vertical outer side of the upper track, and the assembly opening has two limiting slots on two opposite sides. The assembly opening is configured for holding two hook-and-loop fastening strips for securing a curtain trim. The at least one track set has a plurality of sliding tracks parallel with each other, and each sliding track has a positioning groove and a corresponding limiting groove at two opposite sides and a storing groove at a bottom side. An end of each positioning groove of the sliding track comprises a sliding block.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment of the present invention.

FIG. 2 is an exploded view of the preferred embodiment of the present invention.

FIG. 3 is an exploded view of another perspective according to the preferred embodiment of the present invention.

FIG. 4 is a schematic diagram showing installation of the blades according to the preferred embodiment of the present invention.

FIG. 5 is a schematic diagram showing the blade being restricted by the rotatable block according to the preferred embodiment of the present invention.

FIG. 6 is a schematic diagram of a single sliding track and its blades according to the preferred embodiment of the present invention.

FIG. 7 is a schematic diagram of the installation of the curtain trim according to the preferred embodiment of the present invention.

FIG. 8 is a cross-sectional and a partial enlarged view of the collapsed state according to the preferred embodiment of the present invention.

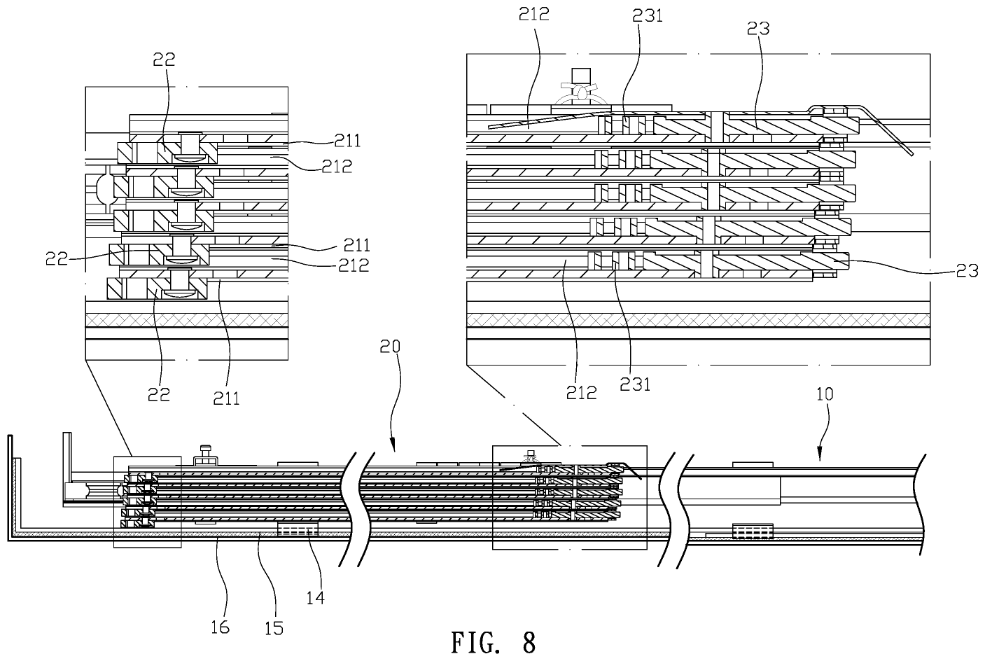

FIG. 9 is a schematic diagram of the linkage state according to the preferred embodiment of the present invention.

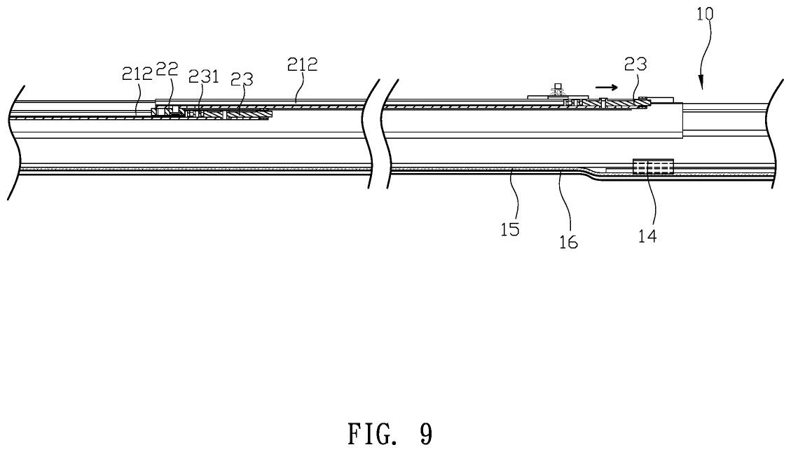

FIG. 10 is a schematic diagram of the sliding block by the linking piece according to the preferred embodiment of the present invention.

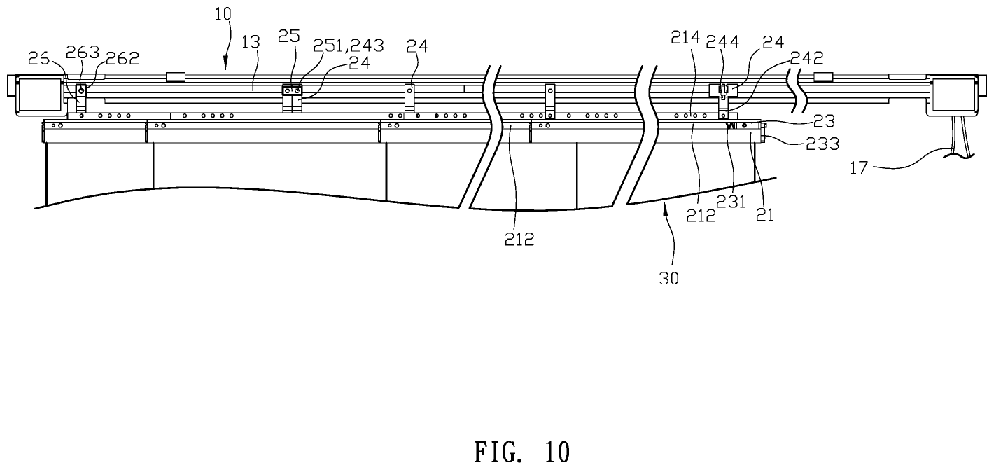

FIG. 11 is a schematic diagram of the three sliding tracks being secured by the linking piece according to the preferred embodiment of the present invention.

FIG. 12 is a perspective view of another embodiment of the present invention.

FIG. 13 is an exploded view of another embodiment of the present creation.

FIG. 14 is another perspective exploded view of another embodiment of the present invention.

FIG. 15 is a schematic diagram showing the unfolded state of another embodiment of the present creation.

FIG. 16 is a schematic view showing the unfolding and overlapping state of another embodiment of the present creation.

FIG. 17 is a schematic diagram of the prior art.

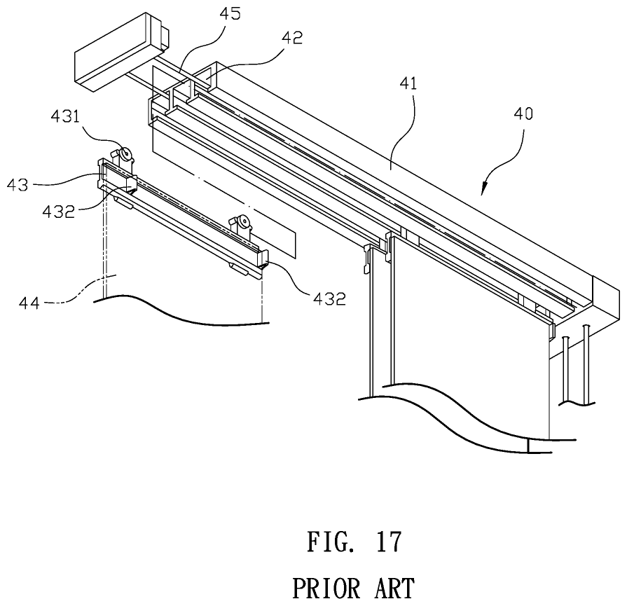

### DETAILED DESCRIPTION OF THE PREFERRED EMBODIMENT

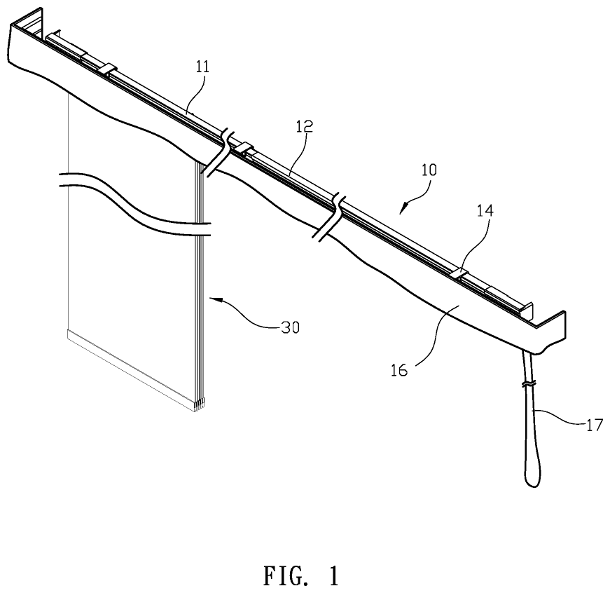

First, please refer to FIGS. 1, 2, and 3. A vertical blind structure comprises: an upper track 10, at least one track set 20 and a plurality of blades 30. The upper track 10 with an adjustable length has an inner track 11 and an outer track 12, and the inner track 11 and the outer track 12 are disposed on a same side and connected to each other with a connecting track 13. The inner and outer tracks 11, 12 of the upper track 10 respectively have an engaging portion 111, 121 and further have a plurality of clamping members 14. The clamping member 14 has a clasping portion 141 and an assembly opening 142 at a vertical outer side of the upper track 10, and the assembly opening 142 has two limiting slots 143 on two opposite sides. The assembly opening 142 is configured for holding two hook-and-loop fastening strips 15 for securing a curtain trim 16. The at least one track set 20 has a plurality of sliding tracks 21 parallel with each other, and each sliding track 21 has a positioning groove 211 and a corresponding limiting groove 212 at two opposite sides and a storing groove 213 at a bottom side. An end of each positioning groove 211 of the sliding track 21 comprises a sliding block 22, and the sliding block 22 further has a blocking plate 221 blocking one end of the storing groove 213. The sliding block 22 is slidably disposed in the limiting groove 212 of another adjacent sliding track 21 and further has two symmetric limiting fins 222 facing the limiting groove 212 of another adjacent sliding track 21. A limiting block 23 has an elastic buffering piece 231 disposed at a front end of each limiting groove 212 of the sliding track 21. A rotatable block 233 pivoted onto a protrusion 232 protruding from the limiting groove 212 of each limiting block 23. A connecting rib 214 is disposed on each sliding track 21, and the connecting rib 214 is provided with a plurality of apertures and a connecting block 24 at its front end. Each connecting block 24 has a first slidable fastening portion 241 and a connecting portion 242 with a corresponding length. Each connecting block 24 utilizes the connecting portion 242 to secure onto the corresponding connecting rib 214 of the sliding track 21, such that the all first slidable fastening portions 241 align and are close to each other. The connecting block 24 has a through aperture 243 facing the opening of the connecting track 13 and is coupled with a linking piece 25 combining at least two connecting blocks 24 on the at least two sliding tracks 21.The very first connecting block 24 on the connecting track 13 further has a rope securing portion 244, and the very last sliding track 21 further has a positioning block 26 on the connecting rib 214. The positioning block 26 further has a second slidable fastening portion 261 engaging with the connecting track 13 of the upper track 10, and an opening of the second slidable fastening portion 261 facing the upper track 10 comprises a packing piece 262 coupled with a locking screw 263. Therefore, the positioning block 26 and the upper track 10 are engaged together. The plurality of blades 30 each has a strip 31 which slides in the storing groove 213 of the sliding track 21 and is limited between the blocking plate 221 and the rotatable block 233 at two ends.

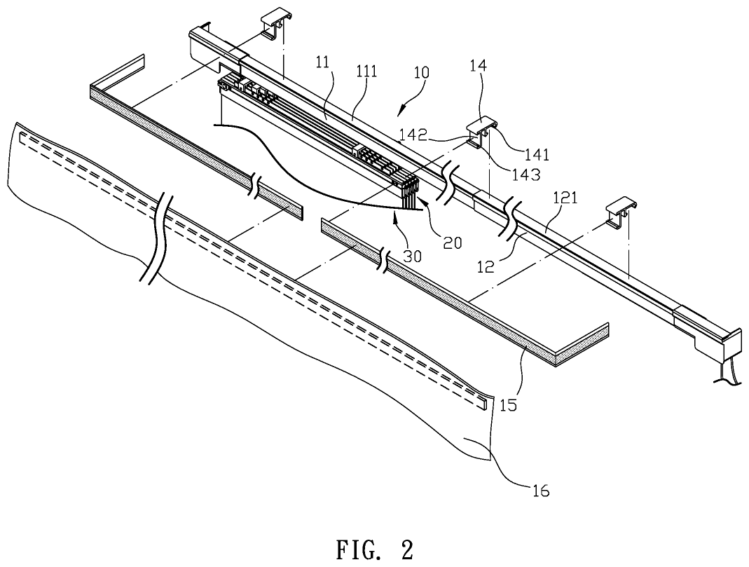

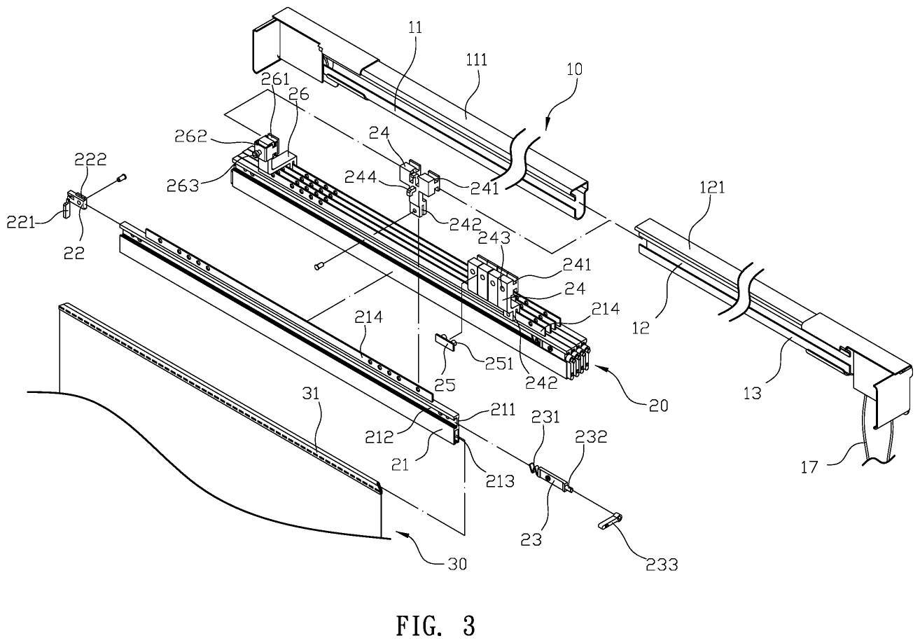

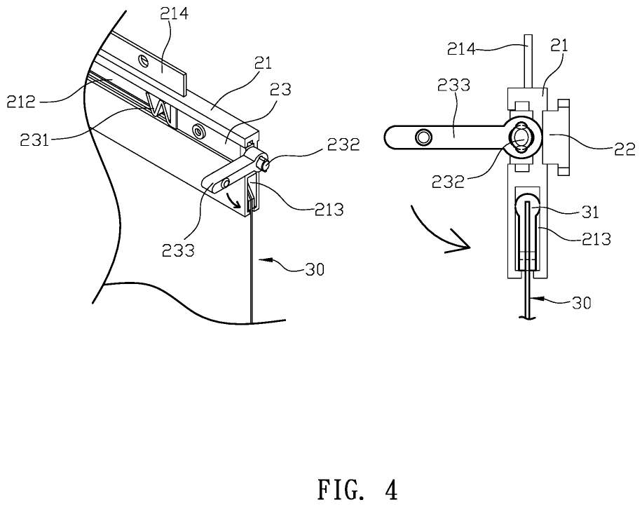

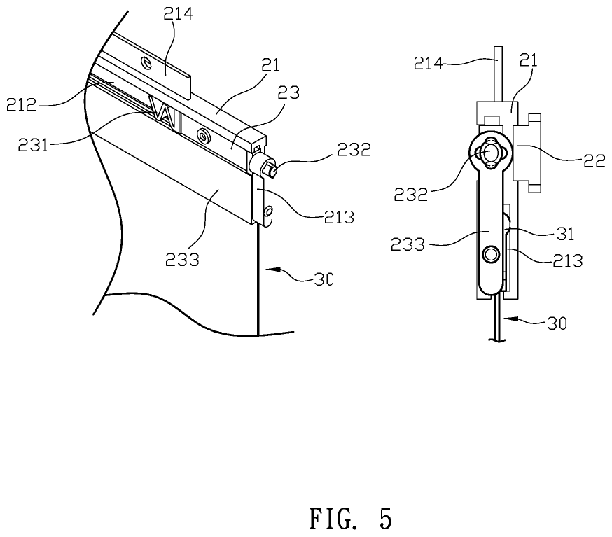

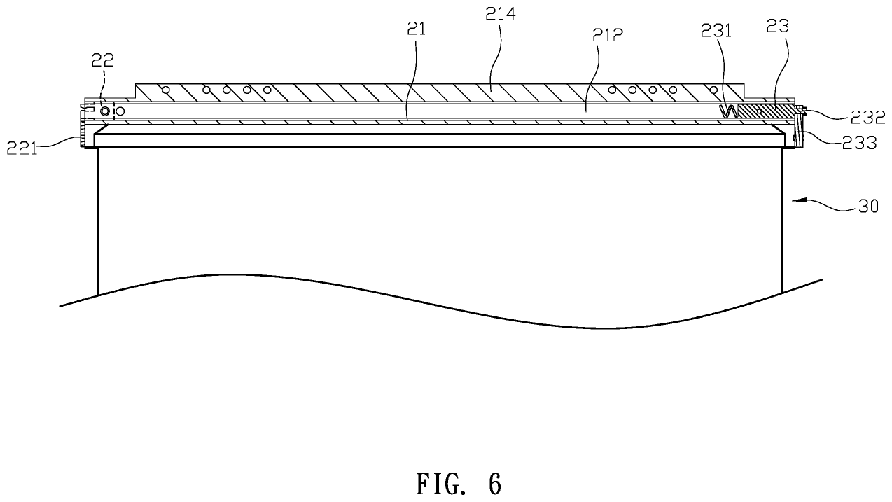

For the structure of the structure, please refer to FIGS. 2 and 3 with FIGS. 4, 5 and 6. Each sliding track 21 of the track set 20 is fixed with a sliding block 22 at the end of the limiting groove 211, and a leading block 23 is disposed at the front end of the positioning groove 212. Each sliding track 21 is disposed side by side, and the sliding block 22 is slid from the end of one positioning groove 212 to another positioning groove 212 of the adjacent sliding track 21. Therefore, the plurality of the sliding tracks 21 are sequentially connected, when the sliding track 21 of the first position is pulled out and the sliding block 22 moves along the positioning groove 212 of the other sliding track 21, the limiting block 23 at the front end of the positioning groove 212 pulls out another sliding track 21, thereby pulling the achieving the interlocking sliding tracks 21 one by one. The storage groove 213 at the bottom of each sliding track 21 is respectively provided with a blades 30, one end of the blades 30 is restricted by the blocking plate 221 of the sliding block 22, and the other end of the blade 30 is blocked by the rotation of the rotatable block 233, thereby completing the installation of the blades 30. Each sliding track 21 of the track set 20 is installed separately with a connecting block 24, and the connecting block 24 utilizes the connecting portion 242 to be attached to the front end of the connecting rib 214 of the sliding track 21 correspondingly. The first slidable fastening portion 241 of the connecting block 24 can be disposed in parallel on the same straight line, the connecting block 24 of the very first sliding track 21 is further provided with the rope securing portion 244, and the sliding track 21 of the last order is further provided with a positioning block 26. The positioning block 26 is also provided with the second slidable fastening portion 261 aligning with the first slidable fastening portion 241 of the connecting block 24, whereby the sliding tracks 21 are mounted in the connecting track 13 of the upper track 10 via the first and second slidable fastening portions 241, 261 of the connecting blocks 24 and the positioning blocks 26. The positioning block 26 is further provided with a packing piece 262 and positioned with the inner wall of the rail 13 through a locking member 263, so that the sliding track 21 at the last is not pulled out and forming a fixed state. The upper track 10 is further coupled with a rope 17 to achieve the sliding displacement of the track set 20, and the rope 17 is tied to the connecting block 24 of the track set 20 in the first order to complete the curtain structure.

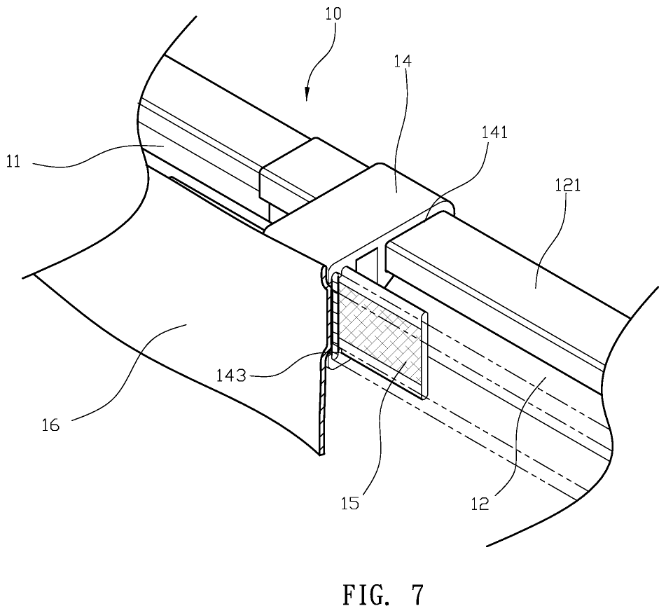

In addition, as shown in FIG. 7, the upper track 10 is further provided with a plurality of clamping members 14, which are fixed onto the engaging portions 111, 121 of the inner and outer tracks 11, 12 by the clasping portions 141. The two fastening strips 15 are fixed by the limiting groove 143 of the assembly opening 142, so that the two fastening strips 15 are staggered and fixed on the same clamping member 14 and can be stretched and retracted along the upper track 10 for adjustable lengths. Finally the curtain fabric 16 is provided for shielding and decorative effect to the upper track 10.

For the actual use of the structure, please refer to FIGS. 1 with 8, 9, 10, and 11. The as the upper track 10 of the vertical blades structure is installed on the wall for windows and floor-to-ceiling windows. When the blades 30 are not spread out in a collapsed state, the blades 30 are pushed to the side of the upper track 10 while the sliding tracks 21 of the track set 20 are pulled by the rope 17. The sliding tracks 21 are parallel and the blades 30 are overlapped into a stack. In order to use the blades 30 for shading, the rope 17 is pulled to move the sliding track 21 of the track set 20 at the first position along the track 13, and the sliding block 22 at the end of the limiting groove 211 moves along the positioning groove 212 of the other sliding track 21 to touch the adjacent limiting block 23. The limiting block 23 is further provided with the buffering elastic piece 231 for reducing the abutting force of the sliding track 21. By pulling the first other sliding track 21 out, other sliding tracks are one by one sliding along the track 13 and the last sliding track 21 is fixed to the upper track 10 by the positioning block 26, so that the track set 20 is accompanied by the blades 30 and forms a fully expanded state on the upper track 10 to achieve indoor shading effect.

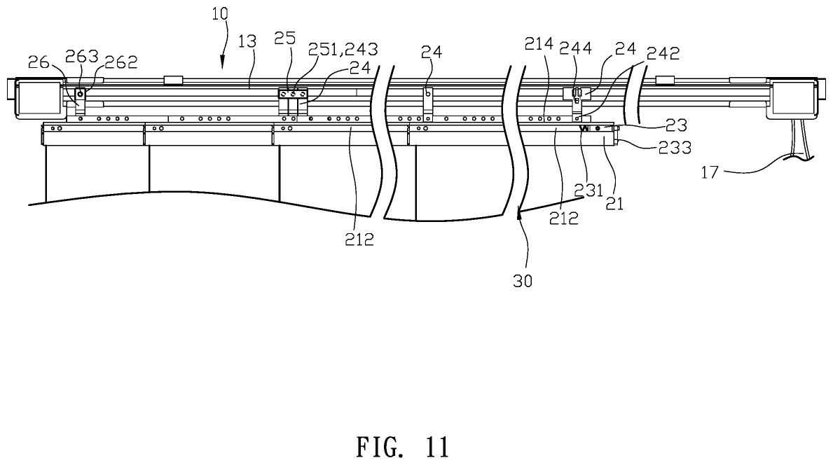

In addition, since the upper track 10 is a combination of the inner track 11 and the outer track 12, the its length can be adjusted by telescopic adjustment, and the number of the sliding tracks 21 of the track set 20 can be adjusted with the length of the upper track 10 accordingly. Furthermore, when the combined length of the inner track 11 and the outer track 12 is shortened, the track set 20 can also be added with the linking pieces 25 to shorten the length of each sliding track 21 and its blades 30. The linking piece 25 is provided with at least two columns 251 corresponding to the connecting block 24, and the two columns 251 are inserted through the through holes 243 of the adjacent two connecting blocks 24. Therefore, the adjacent two connecting blocks 24 are synchronously pulled out, and the two sliding tracks 21 and the attached blades 30 are simultaneously pulled out, achieving the shorten of the upper track 10 or not fully expanded effect. Moreover, the linking piece 25 has a three columns 251, as show in FIG. 11, which allows the three sliding tracks 21 of the track set 20 and attached blades 30 to be simultaneously pulled out to reduce the pulled out area of two sliding tracks 21 and two blades 30.

On the other hand, in order to spread out the blades 30, the sliding track 21 of the first position is retracted along the track 13 of the upper track 10 by pulling the rope 17 reversely. When the sliding track 21 sliding in the reverse direction, the connecting block 24 abuts against the connecting block 24 of the other sliding track 21, and then the other sliding track 21 is pushed back and pulls back others one by one.

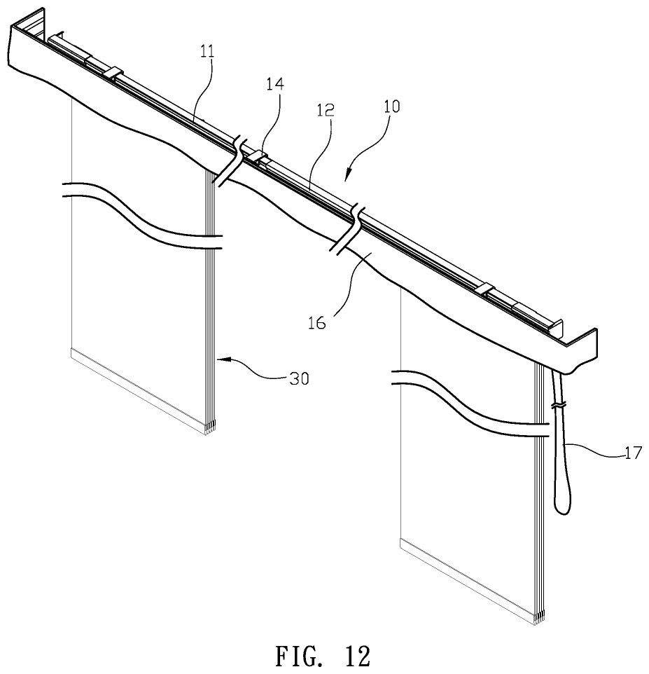

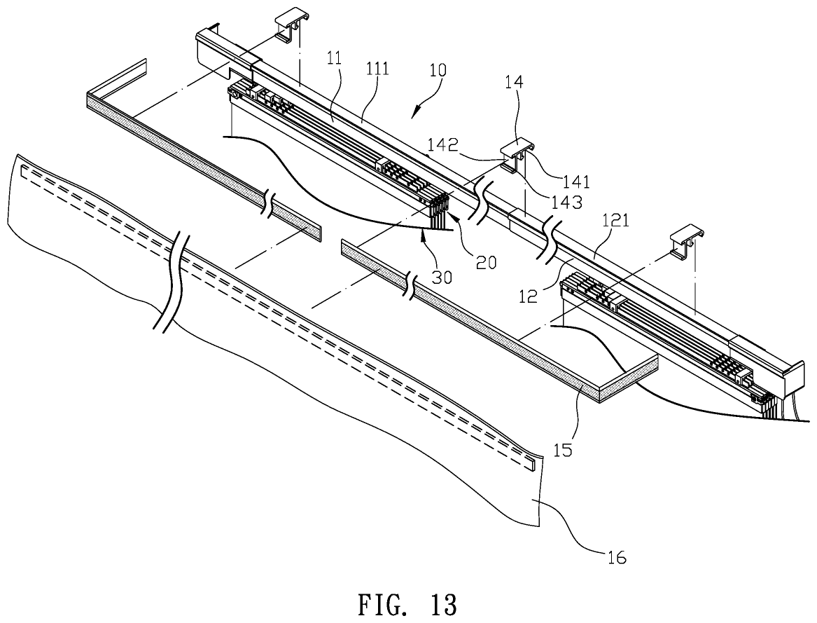

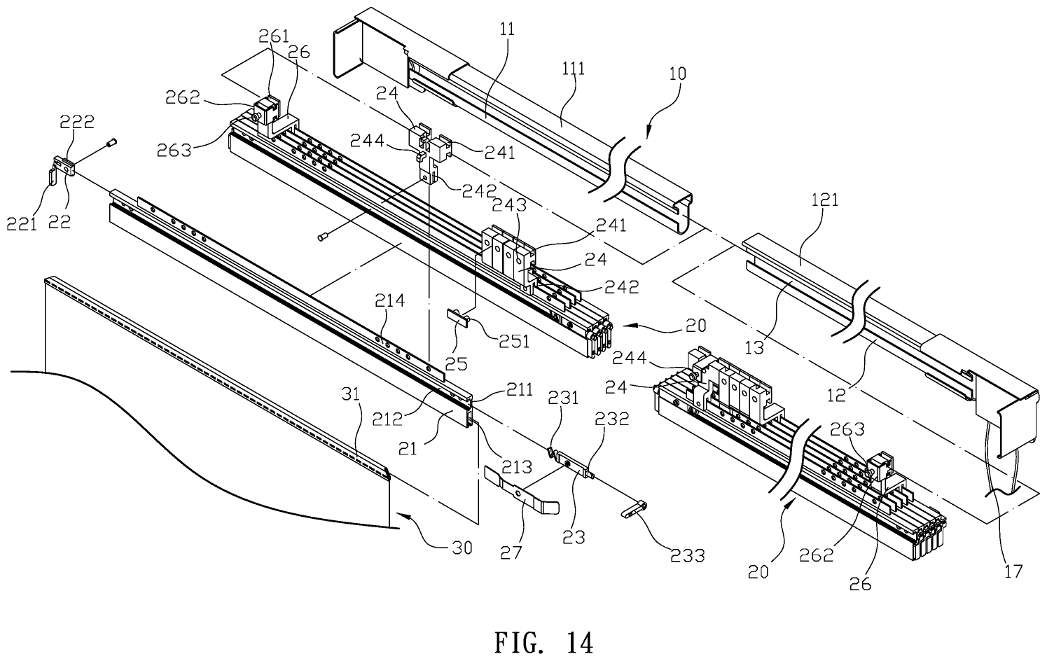

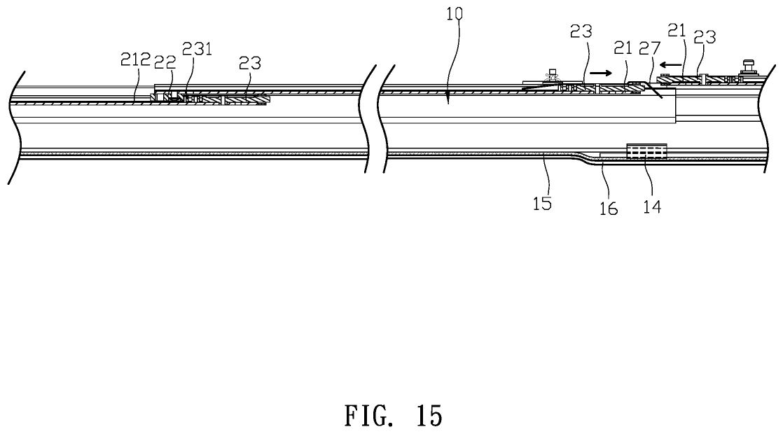

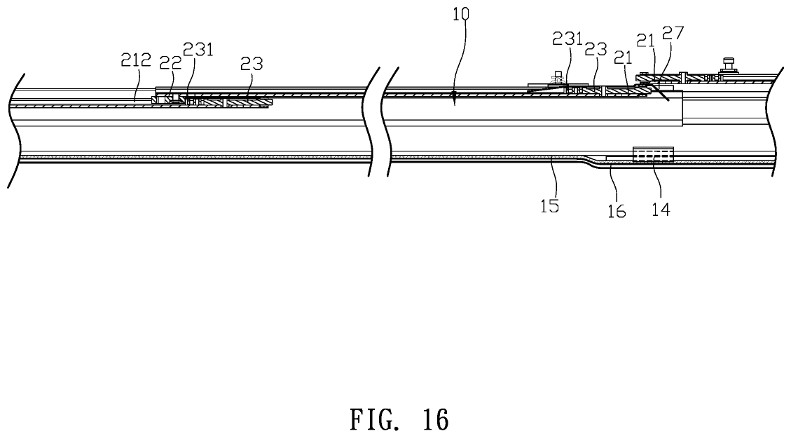

In another embodiment of the structure, as shown in FIGS. 12, 13, 14, 15, and 16, the upper track 10 can also accommodate two track sets 20, and the two track sets 20 are mounted on the outer ends of the inner track 11 and the outer track 12 respectively. The two track sets 20 are provided with the rope securing portions 244 located on the connecting block 24 of the sliding track 21 at the first position. The sliding track 21 at the last position is provided with a positioning block 26 fixed by a packing piece 262 with a locking screw 263. Afterward, the two track sets 20 are able to being closed and separated from each other, the sliding tracks 21 of the two track set 20 are misaligned, so that the sliding tracks 21 of the two track sets 20 in the first position on the opposite side staggered to form a closed state. Moreover, an offsetting elastic member 27 is disposed at the front end of an inner side of the sliding track 21 and used to ensure the offset state of the two sliding tracks 21.

With the structure of the above specific embodiment, the following benefits can be obtained: (1) Each sliding track 21 of the track set 20 is installed separately with a connecting block 24, and the connecting block 24 utilizes the connecting portion 242 to be attached to the front end of the connecting rib 214 of the sliding track 21 correspondingly. Therefore, the connecting block 24 and the slidable fastening portion 241 of each sliding tra0ck 21 can be located on the same line and installed on the connecting track 13 of the upper the track 10, so the size of the upper track 10 can be greatly reduced, and the package volume can be effectively reduced too.

(2) Further, an end of each positioning groove 211 of the sliding track 21 comprises a sliding block 22, and the sliding block 22 further has a blocking plate 221 blocking one end of the storing groove 213, a limiting block 23 has an elastic buffering piece 231 disposed at a front end of each limiting groove 212 of the sliding track 21, and the limiting block 23 further has a rotatable block 233. Therefore, that the blade 30 can be mounted in the storage groove 213 and limited by the blocking plate 221 and the rotatable block 233, thereby preventing the blade 30 from falling off. When the blade 30 needs to be replaced, the blade 30 can be easily pulled out by rotating the rotatable block 233.

(3) In addition, the upper track 10 is further equipped with the plurality of clamping members 14 for securing the two fastening strips 15, and then the curtain fabric 16 can be attached onto the fastening strips 15 to provide the shading effect and decoration.

Although the present invention has been explained in relation to its preferred embodiment, it is to be understood that many other possible modifications and variations can be made without departing from the spirit and scope of invention as hereinafter claimed.

What is claimed is:

1. A vertical blind structure comprising:
an upper track with an adjustable length having an inner track and an outer track, the inner track and the outer track disposed on a same side and connected to each other; the upper track further having a plurality of clamping members, each clamping member comprising an assembly opening having at least two hook-and-loop fastening strips configured for securing a curtain trim,
at least one track set having a plurality of sliding tracks parallel with each other, each sliding track having a positioning groove and a corresponding limiting groove at two opposite sides and a storing groove at a bottom side;
an end of each positioning groove comprising a sliding block, the sliding block further having a blocking plate blocking one end of the storing groove, the sliding block slidably disposed in the limiting groove of another adjacent sliding track; a limiting block having a elastic buffering piece disposed at a front end of each limiting groove of the sliding track; a rotatable block pivoted onto each limiting block; a connecting rib disposed on each sliding track, the connecting rib provided with a plurality of apertures and a connecting block, each connecting block having a first slidable fastening portion and a connecting portion with a corresponding length, each connecting block utilizing the connecting portion to secure onto the corresponding connecting rib of the sliding track, such that the first slidable fastening portions align and are close to each other; the very first connecting block on the sliding track further having a rope securing portion, the very last sliding track further having a positioning block on the connecting rib engaging with the upper track; and
a plurality of blades each having a strip sliding in the storing groove of the sliding track and limited between the blocking plate and the rotatable block at two ends of the storing groove.

2. The vertical blind structure as claimed in claim 1, wherein the inner and outer tracks of the upper track respectively have an engaging portion, the clamping member has a clasping portion and an assembly opening, and the assembly opening further has two limiting slots on two opposite sides.

3. The vertical blind structure as claimed in claim 1, wherein the positioning block further has a second slidable fastening portion engaging with the upper track, and an opening of the second slidable fastening portion facing the upper track comprises a packing piece coupled with a locking screw.

4. The vertical blind structure as claimed in claim 1, wherein the connecting block has a through aperture facing the opening of the connecting track and is coupled with a linking piece combining at least two connecting blocks on the at least two sliding tracks.

5. The vertical blind structure as claimed in claim 4, wherein the linking piece further has at least two columns corresponding to the two connecting blocks.

6. The vertical blind structure as claimed in claim 1, wherein the sliding block further has two symmetric limiting fins facing the limiting groove of the adjacent sliding track.

7. The vertical blind structure as claimed in claim 1, wherein the two track sets are respectively disposed at an outer end of the inner track and the outer track and are capable of overlapping together and opening away from each other.

8. The vertical blind structure as claimed in claim 7, wherein each sliding track of the two track sets are offset from each other, such that the very first positioned sliding track is movable close to the two track sets to overlap together, and the second position sliding track further has an offsetting elastic member.

9. The vertical blinds structure as claimed in claim 1, wherein the upper track further has a pulling rope for moving the track set.
